(19) United States
(12) Patent Application Publication
(10) Pub. No.: US 2026/0359404 A1
(43) Pub. Date: Nov. 12, 2026

(54) SECURE REMOTE INTERACTION USING PORTABLE TRANSACTION DEVICE

(71) Applicant: VISA INTERNATIONAL SERVICE ASSOCIATION, SAN FRANCISCO, CA (US)

(72) Inventors: Daniel Townsend & Roesbery, Frisco, TX (US); Sonia Gupta, Pleasanton, CA (US); Yuexi Chen, Foster City, CA (US); Ratna Deepthi Jarugu, Santa Clara, CA (US); Priyanka Bolleni, San Francisco, CA (US)

(73) Assignee: VISA INTERNATIONAL SERVICE ASSOCIATION, SAN FRANCISCO, CA (US)

(21) Appl. No.: 19/475,285

(22) PCT Filed: Apr. 16, 2024
(86) PCT No.: PCT/US2024/024803

§ 371 Date: Oct. 14, 2025

Related U.S. Application Data
(60) Provisional application No. 63/496,809, filed on Apr. 18, 2023.

(51) Int. Cl. G06F 21/31; G06F 9/50

(52) U.S. Cl. CPC G06F 21/31; G06F 9/5027

(57) ABSTRACT

An exemplary communication device receives transaction data associated with an e-commerce transaction. The communication device provides, to a portable transaction device of a user, the transaction data via short range wireless communication. The portable transaction device generates a cryptogram based at least on the transaction data and a credential associated with an account. The communication device receives, from the portable transaction device, a payload including at least the cryptogram via the short range wireless communication; and transmits, to a token service computer, a token provisioning request message comprising the cryptogram. The communication device receives, from the token service computer, a token provisioning response message comprising a one-time use token associated with the credential upon validation of the cryptogram by a validation server; and transmits the one-time use token to a resource provider computer to finalize the e-commerce transaction.

### CROSS-REFERENCES TO RELATED APPLICATIONS

This application claims benefit under 35 USC § 119(e) to U.S. Provisional Patent Application No. 63/496,809 filed Apr. 18, 2023 and entitled “Secure Remote Interaction Using Portable Transaction Device,” the disclosure of which is incorporated by reference herein in their entirety for all purposes.

### BACKGROUND

In a typical e-commerce transaction to gain access to a resource (e.g., a good or service, secure data, etc.) via a remotely located resource provider computer (e.g., via the Internet), a user will provide a credential (e.g., an account number, etc.) on the resource provider website to pay for the transaction. However, the credentials provided on websites are prone to be compromised through hacking or social engineering.

Such e-commerce transactions where the user cannot physically present their payment device to a store employee for verification are generally referred to as “card-not-present” transactions. The user will simply enter an account identifier to a field provided on the merchant website.

On the other hand, for in-person transactions, a user can present a user payment device such as a card to a client terminal to access the resource. The user payment device in this situation often has additional security information thereon (e.g., a shared secret, a cryptogram, etc.) which can make remote transactions more secure. Any unauthorized person would need to be in possession of the user payment device in order to successfully impersonate an authorized user in a transaction.

However, conventional e-commerce transactions cannot profit from this additional security information (e.g., a cryptogram) associated with the user payment device. In addition, even in the in-person transactions that can use this additional security information, the additional security information is provided to the resource provider, which can then be reverse engineered to obtain the actual account credential.

Moreover, conventional processing message standards for card-not-present transactions does not allow for incorporating a cryptogram that is retrieved from the user payment device. Modifying conventional processing message standards for card-not-present transactions would have a considerable impact on the infrastructure and ecosystem established for processing these transactions.

Embodiments address these and other problems.

### SUMMARY

Embodiments are directed to token provisioning systems and methods.

Some embodiments provide a method performed by a communication device. The method includes receiving, from a resource provider computer operating a resource provider site, transaction data associated with a transaction conducted at the resource provider site by a user. The method then includes providing, to a portable transaction device operated by the user, the transaction data via short range wireless communication. The portable transaction device generates a cryptogram based at least on the transaction data and a credential associated with an account. The method further includes receiving, from the portable transaction device, a payload including at least the cryptogram via the short range wireless communication. The communication device then transmits, to a token service computer, a token provisioning request message comprising at least the cryptogram. The method includes receiving, from the token service computer, a token provisioning response message comprising a one-time use token associated with the credential upon validation of the cryptogram by a validation server. The method also includes transmitting the one-time use token to the resource provider computer to finalize the transaction on the resource provider site. The resource provider computer generates and transmits an authorization request message comprising the one-time use token to an authorizing entity computer for authorization.

Various embodiments provide a communication device comprising a processor; and a non-transitory computer readable medium, comprising code, executable by the processor to implement steps comprising receiving, from a resource provider computer operating a resource provider site, transaction data associated with a transaction conducted at the resource provider site by a user; and providing, to a portable transaction device operated by the user, the transaction data via short range wireless communication. The portable transaction device generates a cryptogram based at least on the transaction data and a credential associated with an account. The steps further comprise receiving, from the portable transaction device, a payload including at least the cryptogram via the short range wireless communication; and transmitting, to a token service computer, a token provisioning request message comprising at least the cryptogram. The steps also comprise receiving, from the token service computer, a token provisioning response message comprising a one-time use token associated with the credential upon validation of the cryptogram by a validation server; and transmitting the one-time use token to the resource provider computer to finalize the transaction on the resource provider site. The resource provider computer generates and transmits an authorization request message comprising the one-time use token to an authorizing entity computer for authorization.

Some embodiments provide a method performed by a token service computer. The method comprises receiving, from a communication device, a token provisioning request message comprising a credential associated with an account and a cryptogram generated based at least on transaction data associated with a transaction and the credential associated with the account. The method also comprises generating a one-time use token associated with the account upon validating the cryptogram with a validation computer; and transmitting the one-time use token to the communication device. The method further comprises receiving, from a transaction processing network, a detokenization request message including the one-time use token; and retrieving the credential associated with the one-time use token upon validating the one-time use token. The method comprises transmitting, to the transaction processing network, the credential associated with the one-time use token, wherein the transaction is processed using the credential.

These and other Embodiments are described in further detail below.

### BRIEF DESCRIPTION OF THE DRAWINGS

FIG. 1 shows an exemplary system and flow diagram according to various Embodiments.

FIG. 2 shows an exemplary system diagram according to various Embodiments.

FIG. 3 shows an exemplary token service computer according to various Embodiments.

FIG. 4 shows an exemplary communication device according to various Embodiments.

FIG. 5 shows an exemplary portable transaction device according to various Embodiments.

### DETAILED DESCRIPTION

Before discussing Embodiments, some description of some terms may be helpful.

A “communication device” may comprise any suitable electronic device that may be operated by a user, which may also provide remote communication capabilities to a network. A “mobile communication device” may be an example of a “communication device” that can be easily transported. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network. Examples of mobile communication devices include mobile phones (e.g., cellular phones), PDAs, tablet computers, net books, laptop computers, personal music players, hand-held specialized readers, etc. Further examples of mobile communication devices include wearable devices, such as smart watches, fitness bands, ankle bracelets, rings, earrings, etc., as well as automobiles with remote communication capabilities. In some embodiments, a mobile communication device can function as a payment device (e.g., a mobile communication device can store and be able to transmit payment credentials for a transaction).

A “portable communication device” may be a portable device that can be transported and be operated by a user, and may include one or more electronic components (e.g., an integrated chip, etc.). A portable communication device according to an embodiment of the invention may be in any suitable form including, but not limited to a mobile phone (e.g., smart phone, cellular phone, etc.), a tablet computer, a portable media player, a personal digital assistant device (PDA), a wearable communication device (e.g., watch, bracelet, glasses, etc.), an electronic reader device, a laptop, a netbook, an ultrabook, etc. A portable communication device may also be in the form of a vehicle (e.g., a car) equipped with communication capabilities.

Portable communication devices according to Embodiments can be configured to communicate with external entities such as remote communication gateways through long range communications technologies and protocols. They may also be configured to communicate with external entities such as access devices using any suitable short or medium range communications technology including Bluetooth (classic and BLE-Bluetooth low energy), NFC (near field communications), IR (infrared), Wi-Fi, etc.

A “portable device” may be a portable transaction device that can be used to conduct a transaction. A portable device may include a storage technology (e.g., electronic memory, magnetic stripe, etc.) to store credentials or tokens associated with an account of a user. A portable device can be in any of the forms described above with respect to the portable communication device, or in the form of a card (e.g., integrated chip card, magnetic stripe card) or a fob, etc. In some embodiments, the portable device and the portable communication device may be the same device, and need not be separate devices. Specific examples of portable devices can include wearable devices, payment cards such as credit, debit, and prepaid cards, vehicles with remote communication capabilities, etc.

A “payment device” may include any suitable device that may be used to conduct a financial transaction, such as to provide payment credentials to a merchant. The payment device may be a software object, a hardware object, or a physical object. As examples of physical objects, the payment device may comprise a substrate such as a paper or plastic card, and information that is printed, embossed, encoded, or otherwise included at or near a surface of an object. A hardware object can relate to circuitry (e.g., permanent voltage values), and a software object can relate to non-permanent data stored on a device. A payment device may be associated with a value such as a monetary value, a discount, or store credit, and a payment device may be associated with an entity such as a bank, a merchant, a payment processing network, or a person. Suitable payment devices can be hand-held and compact so that they can fit into a user's wallet and/or pocket (e.g., pocket-sized). Example payment devices may include smart cards, magnetic stripe cards, keychain devices (such as the Speedpass™ commercially available from Exxon-Mobil Corp.), etc. Other examples of payment devices include payment cards, smart media, transponders, and the like. If the payment device is in the form of a debit, credit, or smartcard, the payment device may also optionally have features such as magnetic stripes. Such devices can operate in either a contact or contactless mode.

A “credential” may be any suitable information that serves as reliable evidence of worth, ownership, identity, or authority. A credential may be a string of numbers, letters, or any other suitable characters, as well as any object or document that can serve as confirmation. Examples of credentials include value credentials, identification cards, certified documents, access cards, passcodes, and other login information, etc.

“Payment credentials” may include any suitable information associated with an account (e.g., a payment account and/or payment device associated with the account). Such information may be directly related to the account or may be derived from information related to the account. Examples of account information may include a PAN (primary account number or “account number”), username, expiration date, and verification values such as CVV, dCVV, CVV2, dCVV2, and CVC3 values.

A “token” may be a substitute value for a credential. A token may be a string of numbers, letters, or any other suitable characters. Examples of tokens include payment tokens, access tokens, personal identification tokens, etc.

A “payment token” may include an identifier for a payment account that is a substitute for an account identifier, such as a primary account number (PAN). For example, a payment token may include a series of alphanumeric characters that may be used as a substitute for an original account identifier. For example, a token “4900 0000 0000 0001” may be used in place of a PAN “4147 0900 0000 1234.” In some embodiments, a payment token may be “format preserving” and may have a numeric format that conforms to the account identifiers used in existing transaction processing networks (e.g., ISO 8583 financial transaction message format). In some embodiments, a payment token may be used in place of a PAN to initiate, authorize, settle, or resolve a payment transaction or represent the original credential in other systems where the original credential would typically be provided. In some embodiments, a payment token may be generated such that the recovery of the original PAN or other account identifier from the token value may not be computationally derived. Further, in some embodiments, the token format may be configured to allow the entity receiving the token to identify it as a token and recognize the entity that issued the token.

“Tokenization” is a process by which data is replaced with substitute data. For example, a payment account identifier (e.g., a primary account number (PAN)) may be tokenized by replacing the primary account identifier with a substitute number (e.g., a token) that may be associated with the payment account identifier. Further, tokenization may be applied to any other information that may be replaced with a substitute value (i.e., token). Tokenization enhances transaction efficiency and security.

A “token issuer,” token provider” or “token service system” can include a system that services tokens. In some embodiments, a token service system can facilitate requesting, determining (e.g., generating) and/or issuing tokens, as well as maintaining an established mapping of tokens to primary account numbers (PANs) in a repository (e.g., token vault). In some embodiments, the token service system may establish a token assurance level for a given token to indicate the confidence level of the token to PAN binding. The token service system may include or be in communication with a token vault where the generated tokens are stored. The token service system may support token processing of payment transactions submitted using tokens by de-tokenizing the tokens to obtain the actual PANs. In some embodiments, a token service system may include a tokenization computer alone, or in combination with other computers such as a transaction processing network computer. Various entities of a tokenization ecosystem may assume the roles of the token service provider. For example, payment networks and issuers or their agents may become the token service provider by implementing the token services according to embodiments of the present invention.

A “token domain” may indicate an area and/or circumstance in which a token can be used. Examples of token domains may include, but are not limited to, payment channels (e.g., e-commerce, physical point of sale, etc.), POS entry modes (e.g., contactless, magnetic stripe, etc.), and merchant identifiers to uniquely identify where the token can be used. A set of parameters (i.e., token domain restriction controls) may be established as part of token issuance by the token service provider that may allow for enforcing appropriate usage of the token in payment transactions. For example, the token domain restriction controls may restrict the use of the token with particular presentment modes, such as contactless or e-commerce presentment modes. In some embodiments, the token domain restriction controls may restrict the use of the token at a particular merchant that can be uniquely identified. Some exemplary token domain restriction controls may require the verification of the presence of a token cryptogram that is unique to a given transaction. In some embodiments, a token domain can be associated with a token requestor.

A “token expiry date” may refer to the expiration date/time of the token. The token expiry date may be passed among the entities of the tokenization ecosystem during transaction processing to ensure interoperability. The token expiration date may be a numeric value (e.g., a 4-digit numeric value). In some embodiments, the token expiry date can be expressed as a time duration as measured from the time of issuance.

A “user” may include an individual. In some embodiments, a user may be associated with one or more personal accounts and/or mobile devices. The user may also be referred to as a cardholder, account holder, or consumer in some embodiments.

A “resource provider” may be an entity that can provide a resource such as goods, services, information, and/or access. Examples of resource providers includes merchants, data providers, transit agencies, governmental entities, venue, and dwelling operators, etc.

A “merchant” may typically be an entity that engages in transactions and can sell goods or services, or provide access to goods or services.

An “acquirer” may typically be a business entity (e.g., a commercial bank) that has a business relationship with a particular merchant or other entity. Some entities can perform both issuer and acquirer functions. Some embodiments may encompass such single entity issuer-acquirers. An acquirer may operate an acquirer computer, which can also be generically referred to as a “transport computer.”

An “authorizing entity” may be an entity that authorizes a request. Examples of an authorizing entity may be an issuer, a governmental agency, a document repository, an access administrator, etc.

An “issuer” may typically refer to a business entity (e.g., a bank) that maintains an account for a user. An issuer may also issue payment credentials stored on a portable transaction device, such as a cellular telephone, smart card, tablet, or laptop to the consumer.

An “access device” may be any suitable device that provides access to a remote system. An access device may also be used for communicating with a merchant computer, a transaction processing computer, an authentication computer, or any other suitable system. An access device may generally be located in any suitable location, such as at the location of a merchant. An access device may be in any suitable form. Some examples of access devices include POS or point of sale devices (e.g., POS terminals), cellular phones, PDAs, personal computers (PCs), tablet PCs, hand-held specialized readers, set-top boxes, electronic cash registers (ECRs), automated teller machines (ATMs), virtual cash registers (VCRs), kiosks, security systems, access systems, and the like. An access device may use any suitable contact or contactless mode of operation to send or receive data from, or associated with, a mobile communication or payment device. In some embodiments, where an access device may comprise a POS terminal, any suitable POS terminal may be used and may include a reader, a processor, and a computer-readable medium. A reader may include any suitable contact or contactless mode of operation. For example, exemplary card readers can include radio frequency (RF) antennas, optical scanners, bar code readers, or magnetic stripe readers to interact with a payment device and/or mobile device. In some embodiments, a cellular phone, tablet, or other dedicated wireless device used as a POS terminal may be referred to as a mobile point of sale or an “mPOS” terminal.

An “authorization request message” may be an electronic message that requests authorization for a transaction. In some embodiments, it is sent to a transaction processing computer and/or an issuer of a payment card to request authorization for a transaction. An authorization request message according to some embodiments may comply with ISO 8583, which is a standard for systems that exchange electronic transaction information associated with a payment made by a user using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCVV (dynamic card verification value), a PAN (primary account number or “account number”), a payment token, a username, an expiration date, etc. An authorization request message may also comprise “transaction information,” such as any information associated with a current transaction, such as the transaction amount, merchant identifier, merchant location, acquirer bank identification number (BIN), card acceptor ID, information identifying items being purchased, etc., as well as any other information that may be utilized in determining whether to identify and/or authorize a transaction.

An “authorization response message” may be a message that responds to an authorization request. In some cases, it may be an electronic message reply to an authorization request message generated by an issuing financial institution or a transaction processing computer. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the transaction processing computer) to the merchant's access device (e.g., POS equipment) that indicates approval of the transaction. The code may serve as proof of authorization.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

New consumer computing devices such as PCs, tablets, and smartphones now come with near field communication (NFC) hardware, which can be used for communication with portable transaction devices such as contactless payment cards.

New consumer computing devices also come with secure computing technologies such as secure elements, trusted execution environments, and trusted platform modules. This enables payment kernel software to run securely on the consumer computing devices, and the payment kernel software can encrypt payment credentials captured from contactless payment cards.

Remote e-commerce payment transactions are processed as card-not-present transactions. Embodiments provide techniques for identifying and reducing fraud in card-not-present transactions using the improved technology of the consumer computing devices. New consumer computing devices have the hardware and software to capture EMV (Europay-Mastercard-Visa) cryptograms from portable transaction devices (e.g., contactless EMV payment cards). Embodiments provide techniques for modifying the card-not-present transaction flow and the messaging to incorporate captured EMV cryptograms without substantial changes in the card-not-present payments infrastructure.

Embodiments provide a new card-not-present authorization protocol and messaging process, which uses a captured EMV cryptogram via the consumer computer device to secure card-not-present authorization. Once an issuer has confirmed the transaction by verifying the cryptogram, the issuer assumes liability for the transaction.

Embodiments include the use of a one-time use token that is obtained based on verification of a cryptogram generated by tapping a portable transaction device to a communication device (e.g., a portable communication device such as a mobile phone or laptop computer) in a remote e-commerce transaction.

Tapping the portable transaction device to the communication device can cause the portable transaction device to generate an EMV cryptogram, which an authorizing entity computer operated by an issuer can validate to enhance security. Normally, a card-not-present authorization request message used in remote e-commerce transaction does not carry an EMV cryptogram, and changing the card-not-present authorization request message protocol can have an impact on the payment infrastructure and ecosystem.

In some conventional cases, a merchant initiated 3-D secure (3DS) step up authentication can be used to convey an EMV cryptogram, which is generated by tapping a portable transaction device such as a payment card to a communication device. The EMV cryptogram is obtained by the merchant, and passed from the merchant to the issuer in a remote e-commerce transaction. However, to support this process, the issuer has to upgrade its 3DS access control server (ACS) to validate the EMV cryptogram. In case of a card-not-present authorization request message that is routed through an unaffiliated payment network and a 3DS service that is outside of a specific ecosystem, a payment processing network (e.g., VisaNet™) has no control or visibility on the EMV cryptogram generated in a format specific to that payment processing network in the transaction.

A protocol that allows a payment network to have control and visibility with respect to an EMV cryptogram, while still supporting unaffiliated payment network routing to meet the compliance requirements, is needed. Issuers also need a solution which minimizes the impact on the card-not-present authorization host.

Embodiments use a token service provider to validate the EMV cryptogram generated from the tapping of a portable transaction device to a communication device. Upon successful validation, a one-time use token is generated, thereby mapping to the PAN to a future card-not-present authorization request message.

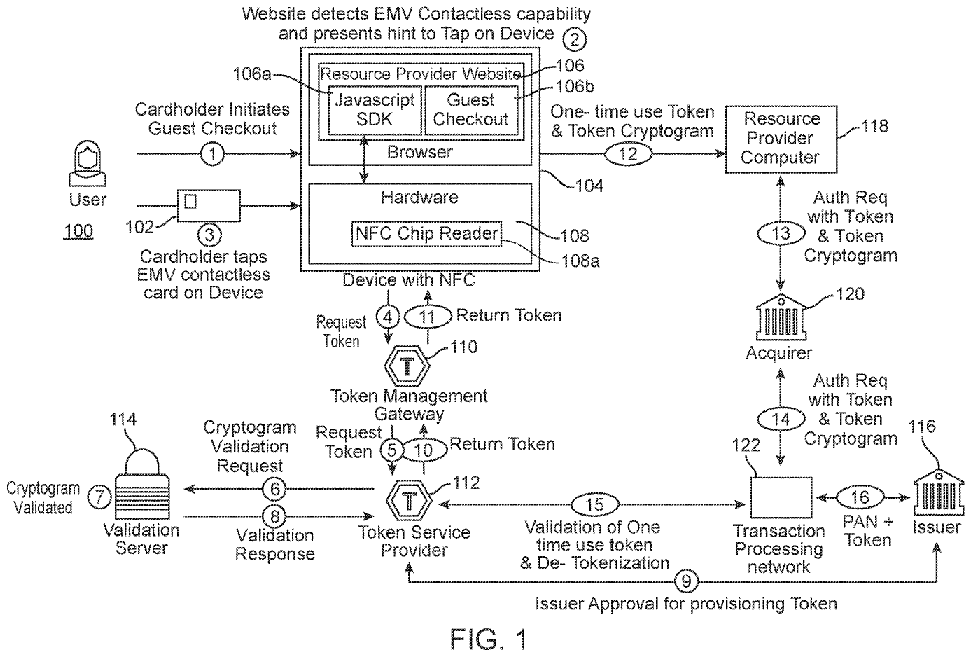

FIG. 1 shows an exemplary system and flow diagram according to various Embodiments. Each of the entities in FIG. 1 can operate one or more computers.

At step 1, a user (cardholder, account holder) 100 may initiate a checkout process for an e-commerce transaction at a resource provider website 106 (e.g., merchant website) displayed on a browser on a communication device 104 (e.g., user device). In some embodiments, the resource provider website 106 may be provided in form of an application (e.g., app) on the communication device 104. For example, the user 100 may activate the guest checkout element 106b on the resource provider website 106.

At step 2, the resource provider website 106 may query the communication device 104 and detect the near field communication (NFC) capability of the communication device 104. For example, the resource provider website 106 may detect, via a SDK component 106a of the resource provider website 106, the presence of an NFC chip reader 108a coupled to the communication device 104. The communication device 104 may receive an interrogation signal from the resource provider website 106 with respect to an NFC capability of the communication device 104. In some embodiments, the NFC chip reader 108a may be an external device coupled to the communication device 104 (e.g., coupled to an I/O port of the communication device 104). Alternatively, the NFC chip reader 108a may be an integral component of the communication device 104. Upon detecting the NFC capability of the communication device 104, the resource provider website 106 may prompt the user 100 to tap their portable transaction device 102 to their communication device 104 to proceed with the e-commerce transaction. For example, the communication device 104 may receive a prompt from the resource provider website 106 to retrieve the credential associated with the account from the portable transaction device of the user, and may display a message on the resource provider website 106 asking the user to tap their portable transaction device 102 to the communication device 104.

At step 3, the user 100 may present (e.g., tap) the portable transaction device 102 to the communication device 104. According to various embodiments, the user communication device 104 receives transaction data associated with the e-commerce transaction from the resource provider website 106. The transaction data may include one or more of a transaction amount, an identifier for the merchant, details about the services or products being purchased. The communication device 104 may provide the transaction data via short range wireless communication to the portable transaction device 102 operated by the user when the user 100 taps the portable transaction device 102 to the communication device 104 (e.g., when the portable transaction device 102 is in short range wireless communication with the communication device 104).

The portable transaction device 102 generates a payload (e.g., a data packet) based at least on the transaction data and a credential associated with an account. The payload includes an EMV cryptogram generated following EMV protocols. In some embodiments, the EMV cryptogram (e.g., “cryptogram”) can be generated by encrypting at least the transaction data associated with the transaction and the primary account number (PAN) or other account identifier. In some embodiments, the transaction data can include a transaction amount for the transaction, which is generated by the resource provider website 106. The transaction data may also include one or more of a merchant country code, merchant verification results, transaction currency code, transaction date, transaction type, an unpredictable number, a transaction counter.

According to various embodiments, the portable transaction device 102 may include an integrated circuit (e.g., chip) that generates the cryptogram using N application cryptogram master key. A session key may be generated using the application cryptogram master key. The session key may be unique for each transaction. The chip then generates the cryptogram (e.g., EMV cryptogram) using the session key and the data by applying an encryption algorithm.

The payload may also include the credential associated with the account (e.g., the PAN), chip data, etc. The PAN, chip data, and the EMV cryptogram may be stored on a memory the portable translation device 102. The communication device 104 receives the payload including at least the cryptogram from the portable transaction device 102 via short range wireless communication (e.g., NFC). For example, the communication device 104 may include an NFC antenna configured to communicate with the portable transaction device 102 to receive the credential from the portable transaction device. The communication device 104 receives the cryptogram from the portable transaction device 102 via the NFC capability of the communication device 104 and the portable transaction device 102.

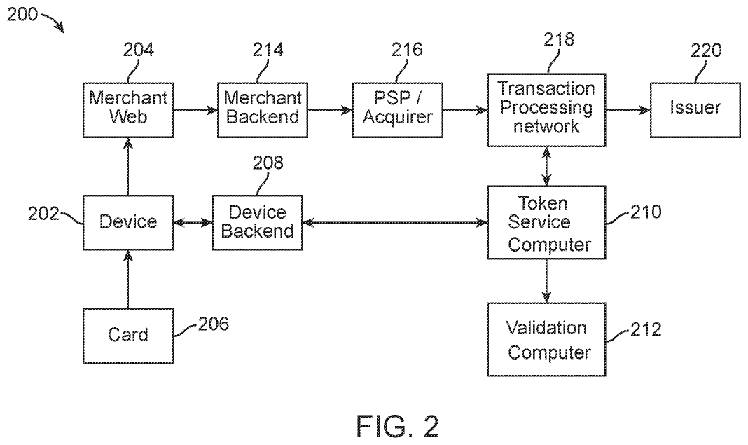

According to various embodiments, the communication device 104 may be in communication with a communication device backend system (e.g., communication device backend system 208 shown in FIG. 2) that may facilitate communication between the communication device 104 and third party entities, such as a token service provider 112. The cryptogram generated by the portable transaction device 102 is not shared with the resource provider website 106 and/or the resource provider computer 118. That is, the EMV cryptogram generated by the portable transaction device 102 bypasses the resource provider website 106 and/or the resource provider computer 118. According to various embodiments, the EMV cryptogram is not a payment credential that can be used to process the e-commerce transaction.

At steps 4 and 5, the communication device 104 may generate and transmit a token provisioning request message comprising at least the cryptogram to the token service provider computer 112. For example, the communication device 104 may incorporate the cryptogram in the token provisioning request message. The token provisioning request message may be routed via the communication device backend system and a token management gateway 110 communicatively coupled to the token service provider computer 112 and the communication device 104/communication device backend system. The token provisioning request message may include at least the EMV cryptogram and request generation of a one-time use token. The token provisioning request message may also include the credential associated with the account (e.g., PAN), and the chip data retrieved from the portable transaction device 102.

At step 6, the token service provider 112 may transmit the credential and the cryptogram to a validation server 114. In some embodiments, if the token provisioning request does not include the credential associated with the account (e.g., captured PAN), the token service provider 112 may retrieve the credential associated with the account (e.g., PAN) based on the EMV cryptogram.

At step 7, the validation server 114 may validate the credential and the cryptogram using a shared secret key, and return a validation response message to the token service provider 112 at step 8. The shared secret key may be the key that is used by the portable transaction device 102 to generate the cryptogram. In some embodiments, the shared secret key may be provided to the validation server 114 by the issuer 116 of the portable transaction device 102 (and the associated account). The validation response message validates the cryptogram confirming that the credential (e.g., captured PAN) is associated with the account. According to various embodiments, each cryptogram may be unique to the associated transaction and may be intended to cryptographically show both the validity of the portable transaction device 102 as well as to ensure that the transaction data exactly matches the current (expected) transaction. Validation of an EMV cryptogram by the validation server 114 results in a stronger validation compared to CVV/dCVV and PAN validation in the conventional systems. A stronger validation results in lower fraudulent transactions.

At step 9, upon successful validation of the cryptogram by the validation server 114, the token service provider 112 may communicate with the issuer 116 (e.g., the entity that issued the portable transaction device 102 and the associated account identified by the PAN) and generate a one-time use token upon receiving issuer approval from the issuer 116. The token service provider 112 may store a mapping between the one-time use token and one or more of the PAN, EMV cryptogram at a token vault. In some embodiments, the token service provider 112 may also generate a token cryptogram along with the one-time use token, and transmit the token cryptogram along with the one-time use token to the communication device 104.

At steps 10 and 11, the token service provider 112 may return a token provisioning response message including at least the one-time use token to the communication device 104 via the communication device backend system and/or the token management gateway 110. For example, the token provisioning response message may include the one-time use token (e.g., “token”:“400012345678901234”) and, optionally, a token cryptogram (generated by the token service provider 112) associated with the one-time use token (e.g., “tokenCryptogram”:“MTIzNDU2Nzg5MDA5ODc2NTQzMjE=”).

The communication device 104 receives the token provisioning response message comprising the one-time use token (and optionally the token cryptogram) from the token service computer. At step 12, the communication device 104 transmits the one-time use token (and optionally the token cryptogram) to the resource provider computer 118 to finalize the transaction on the resource provider site 106. According to various embodiments, the resource provider computer 118 generates and transmits an authorization request message (e.g., a card-not-present authorization request message) comprising the one-time use token to an authorizing entity computer (e.g., the issuer 116) for authorization. In some embodiments, the authorization request message may include the token cryptogram along with the one-time use token. The authorization request message may be routed to the issuer 116 through an acquirer 120 (at step 13) and a transaction processing network 122 (at step 14).

The transaction processing network 122 may include data processing subsystems, networks, and operations used to support and deliver authorization services, exception file services, and clearing and settlement services. An exemplary transaction processing network 122 may include VisaNet™. Transaction processing networks such as VisaNet™ are able to process credit card transactions, debit card transactions, and other types of commercial transactions. VisaNet™, in particular, includes a VIP system (Visa Integrated Payments system), which processes authorization requests and a Base II system which performs clearing and settlement services. The transaction processing network 122 may use any suitable wired or wireless network, including the Internet.

According to various embodiments, the token service provider 112 and the transaction processing network 122 may be managed by separate entities. In other embodiments, the token service provider 112 and the transaction processing network 122 may be managed a same entity (e.g., VisaNet™). In such embodiments, the authorizing entity computer (e.g., the issuer 116) may authorize the transaction at least based on receiving an indication of the validation of the cryptogram provided by the transaction processing network 122.

At step 15, the transaction processing network 122 may send the token to the token service provider 112 for de-tokenization. According to various embodiments, the one-time use token can only be de-tokenized by the token service provider computer 112. Accordingly, even when the token service provider 112 and the transaction processing network 122 are managed by separate entities, the token service provider 112 will oversee all transactions conducted with the one-time use token generated by the token service provider 112. For example, the token service provider 112 may be associated with a first transaction processing network. The e-commerce transaction may be routed through a second transaction processing network. The second transaction processing network, upon receiving the one-time use token generated by the first transaction processing network, will transmit the one-time use token to the token service provider associated with the first transaction processing network for de-tokenization, thereby notifying the first transaction processing network of the e-commerce transaction.

The token service provider 112 performs checks on the token (e.g., single use expiry) and the token cryptogram, if present, (to determine whether the token has been used). Upon successful validation of the token and/or the token cryptogram, the token service provider 112 returns the PAN associated with token to the transaction processing network 122.

At step 16, the transaction processing network 122 may send the card-not-present authorization request message with the PAN to the issuer 116 with an indicator that indicates that the EMV cryptogram has been previously validated by the transaction processing network 122 (e.g., the token service provider 112 managed by the same entity as the transaction processing network 122) and/or the validation server 114.

Upon receiving the card-not-present authorization request message with the PAN and the EMV cryptogram validated indicator, the issuer 116 (via an authorizing entity computer) may execute a risk algorithm to approve or decline the authorization request message with this new data, without the need to change the card-not-present authorization host system.

At the end of the day or any other suitable period of time, a clearing and settlement process is performed between the PSP/acquirer 120, the transaction processing network 122, and the issuer 116.

FIG. 2 shows an exemplary system diagram according to various Embodiments. As discussed in connection with FIG. 1, a merchant website 204, through a communication device 202, may detect the tap capability of the communication device 202 when a user starts a checkout for an e-commerce transaction on the merchant website 204. If the tap capability is supported, the merchant website 204 prompts a user of the communication device 202 to tap (e.g., present) the portable transaction device 206 (e.g., payment card) to the communication device 202 to provide payment information for the e-commerce transaction.

The user may tap the portable transaction device 206 to the communication device 202. The portable transaction device 206 may then generate a data packet including a PAN, chip data, and an EMV cryptogram following the predetermined EMV protocols. The data packet is captured by the communication device 202 and a communication device backend system 208 associated with the communication device 202. The EMV cryptogram can be generated by encrypting at least transaction data associated with the transaction and the PAN or other card identifier. In some embodiments, the transaction data can include a transaction amount for the transaction, which was generated by the merchant website 204.

The communication device 202 along with the communication device backend system 208 may send the captured PAN, the chip data and the EMV cryptogram to a token service computer 210 in a one-time use token provisioning request message.

The token service computer 210 sends the received PAN, the chip data and the EMV cryptogram to a validation computer 212 so that the validation computer 212 can validate the cryptogram using a shared secret key. Upon successful validation by the validation computer 212, the token service computer 210 generates a one-time use token, maps the one-time use token to the PAN, and returns the one-time use token to the communication device backend system 208 in a provisioning response message. Optionally, the one-time use token may have a token cryptogram associated therewith.

The communication device backend system 208 then sends the received one-time use token to merchant website 204 via the communication device 202. The merchant website 204 sends the one-time use token to the merchant backend system 214 for payment processing. The merchant backend system 214 can then send a card-not-present authorization request message including the one-time use token to an unaffiliated payment network via a payment service provider (e.g., acquirer) 216 using merchant choice of transaction processing network 218.

In embodiments where the transaction processing network 218 is not affiliated with the token service computer 210, the transaction processing network 218 may identify that the one-time use token belongs to a different transaction processing network, e.g., the token's BIN is within BIN range of the different transaction processing network. The transaction processing network 218 then makes a call out to the token service computer 210 affiliated with the different transaction processing network for detokenization. The token service computer 210 performs validation checks on the token (e.g., checks whether the single use has expired), and checks whether the token cryptogram is present. Upon successful validation of the token and/or the token cryptogram, the token service computer 210 returns the PAN associated with token to the transaction processing network 218.

The transaction processing network 218 may then send a modified card-not-present authorization request message including the PAN to the issuer 220. Upon receiving the modified card-not-present authorization request message including the PAN, the issuer 220 processes the modified card-not-present authorization request message. At the end of the day or any other suitable period of time, a clearing and settlement process is performed between the PSP/acquirer 216, the different transaction processing network, and the issuer 220.

In Embodiments, all tap to device transactions can be visible to a payment processing network that is affiliated with the token service computer that generates the one-time use token. The one-time use token can only be de-tokenized by the affiliated payment processing network. Embodiments can also comply with a merchant's routing choice. The benefits to the issuer include minimizing the impact to the card-not-present authorization host, while allowing a user to tap their card to a communication device to obtain an EMV cryptogram. Embodiments use a one-time use token to map the tap to a device PAN and cryptogram validation result in a remote e-commerce transaction.

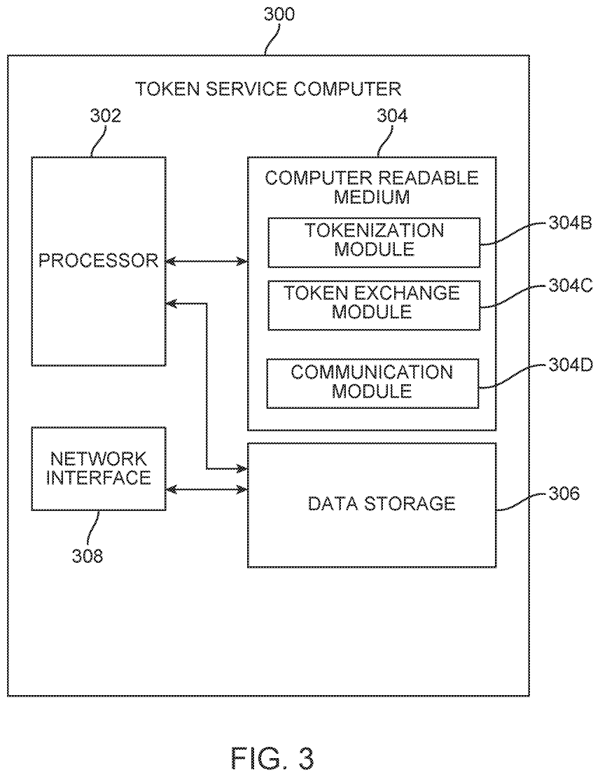

FIG. 3 shows an exemplary token service computer according to various Embodiments. The token service computer 300 may comprise a processor 302, which may be coupled to a computer readable medium 304, data storage 306, and a network interface 308.

The computer readable medium 304 may comprise several software modules including a tokenization module 304B, a token exchange module 304C, and a communication module 304D.

The tokenization module 304B may generate a one-time use token using any suitable encryption algorithms to encrypt data in Embodiments. Suitable data encryption algorithms may include DES, triple DES, AES, etc. It may also store encryption keys that can be used with such encryption algorithms. The tokenization module 304B may utilize symmetric or asymmetric encryption techniques to encrypt and/or verify data. Keys that may be used by the tokenization module 304B may be securely stored in the data storage 306.

The tokenization module 304B may also comprise code that causes the processor 302 to generate and provide one-time use tokens. For example, the tokenization module 304B may contain logic that causes the processor 302 to generate a one-time use token and/or associate the one-time use token or cryptogram with a set of user credentials.

The exchange module 304C may comprise code that causes the processor 302 to detokenize one-time use tokens (e.g., to determine the credential or PAN corresponding to a one-time use token). For example, the exchange module 304C may contain logic that causes the processor 302 to identify a one-time use token at the data storage 306 and retrieve a set of credentials (e.g. PAN) corresponding to the one-time use token from the data storage 306.

The communication module 304D may comprise code that causes the processor 302 to generate messages, forward messages, reformat messages, and/or otherwise communicate with other entities. For example, the communication module 304D may comprise code that causes the processor 302 generate a validation request message to be transmitted to a validation server to validate the EMV cryptogram provided in a token request before a one-time use token is generated. A token record may then be stored in a token record database indicating that the token is associated with a certain user or a certain set of credentials.

The computer readable medium 304 may comprise code executable by the processor 302, to perform operations comprising: receiving, from a communication device, a token provisioning request message comprising a credential associated with an account and a cryptogram generated based at least on transaction data associated with a transaction and the credential associated with the account; generating a one-time use token associated with the account upon validating the cryptogram with a validation computer; transmitting the one-time use token to the communication device; receiving, from a transaction processing network, a detokenization request message including the one-time use token; retrieving the credential associated with the one-time use token upon validating the one-time use token; and transmitting, to the transaction processing network, the credential associated with the one-time use token, wherein the transaction is processed using the credential.

The data storage 306 may store tokens and their associated credentials in a database (e.g., token vault).

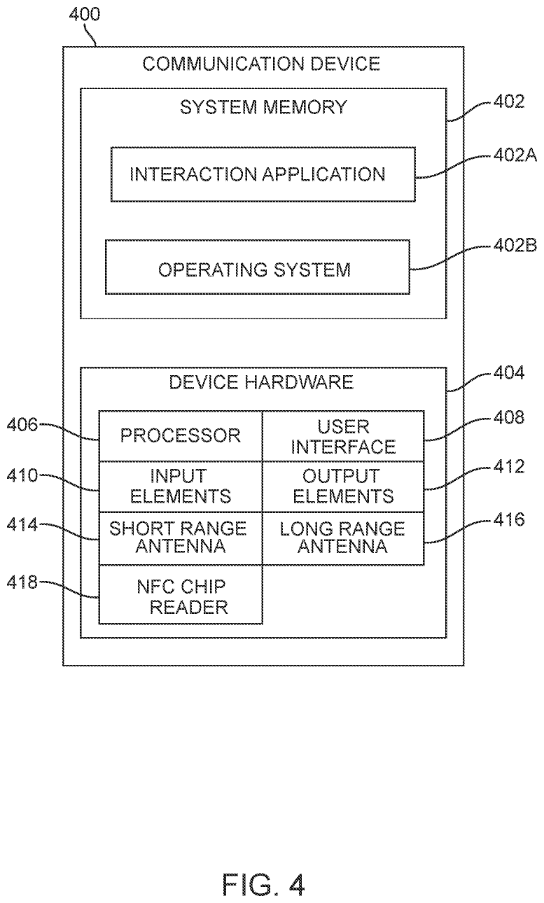

FIG. 4 shows an exemplary communication device according to various Embodiments. Communication device 400 may include device hardware 404 coupled to a system memory 402.

Device hardware 404 may include a processor 406, a short range antenna 414, a long range antenna 416, input elements 410, a user interface 408, output elements 412 (which may be part of the user interface 408), and an NFC chip reader 418. Examples of input elements may include microphones, keypads, touchscreens, sensors, etc. Examples of output elements may include speakers, display screens, and tactile devices. The processor 406 can be implemented as one or more integrated circuits (e.g., one or more single core or multicore microprocessors and/or microcontrollers), and is used to control the operation of communication device 400. The processor 406 can execute a variety of programs in response to program code or computer-readable code stored in the system memory 402, and can maintain multiple concurrently executing programs or processes.

The long range antenna 416 may include one or more RF transceivers and/or connectors that can be used by communication device 400 to communicate with other devices and/or to connect with external networks. The user interface 408 can include any combination of input and output elements to allow a user to interact with and invoke the functionalities of communication device 400. The short range antenna 414 may be configured to communicate with external entities through a short range communication medium (e.g., using Bluetooth, Wi-Fi, infrared, NFC, etc.). For example, the short range antenna 414 may be configured to communicate with a portable transaction device. The long range antenna 416 may be configured to communicate with a remote base station, a remote server (e.g., device backend computer, or a token service computer), and a remote cellular or data network, over the air.

The system memory 402 can be implemented using any combination of any number of non-volatile memories (e.g., flash memory) and volatile memories (e.g. DRAM, SRAM), or any other non-transitory storage medium, or a combination thereof media. The system memory 402 may store computer code, executable by the processor 406, for performing any of the functions described herein.

The system memory 402 may also store an interaction application 402A (e.g. a web browser or a merchant application), and an operating system 402B, among other components. The interaction application 402A may include instructions or code initiating and conducting an e-commerce transaction with an external device such as the resource provider computer. The interaction application 402A may be configured to display a resource provider computer website on the communication device 400.

The system memory 402 may comprise code executable by the processor 406, to perform operations comprising: receiving, from a resource provider computer operating a resource provider site, transaction data associated with a transaction conducted at the resource provider site by a user; providing, to a portable transaction device operated by the user, the transaction data via short range wireless communication, wherein the portable transaction device generates a cryptogram based at least on the transaction data and a credential associated with an account; receiving, from the portable transaction device, a payload including at least the cryptogram via the short range wireless communication; transmitting, to a token service computer, a token provisioning request message comprising at least the cryptogram; receiving, from the token service computer, a token provisioning response message comprising a one-time use token associated with the credential upon validation of the cryptogram by a validation server; and transmitting the one-time use token to the resource provider computer to finalize the transaction on the resource provider site, wherein the resource provider computer generates and transmits an authorization request message comprising the one-time use token to an authorizing entity computer for authorization.

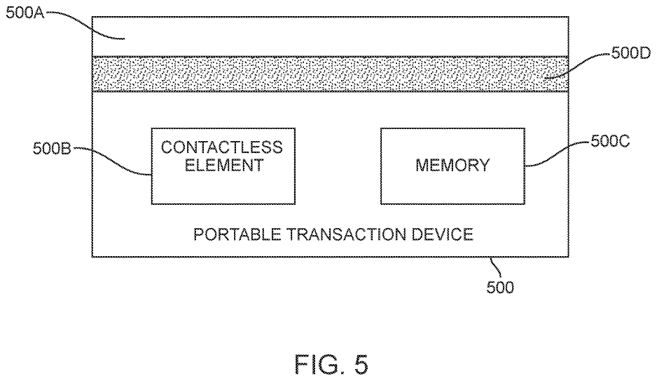

FIG. 5 shows an exemplary portable transaction device according to various Embodiments. The exemplary portable transaction device may be in form of a payment card. The portable transaction device 500 comprises a substrate 500A such as a plastic substrate. A contactless element 500B for interfacing with a data access or data transfer device may be on or embedded within the user device substrate 500A. The contactless element 500B may include a chip and may include the capability to communicate and transfer data using near field communications (NFC) technology or other short range communications technology.

The portable transaction device 500 may also include a memory 500C, which may store user information such as an account number, expiration date, and a username. In some cases, the memory 500C may include a secure element, and/or may also store information such as access data. Information in the memory 500C can be transmitted by the portable transaction device 500 to another device using the contactless element 500B. For example, the contactless element 500B may receive transaction data from a communication device, generate a cryptogram based at least on the transaction data and a credential stored on the memory 500C, and transmit the cryptogram to the communication device. The portable transaction device 500 may be assigned to a user by an authorizing entity, such as an issuer bank. Information may also be printed or embossed on the substrate 500A. The substrate 500A may also have a magnetic stripe 500D that may store duplicate and/or additional data.

Embodiments have several advantages. First, the card-not-present transaction flow and messaging is not impacted. Second, a liability shift is achieved if the card cryptogram is confirmed in an authentication process. Third, step-up authentication with the card cryptogram can be frictionless compared to other mechanisms such as OTP. Also, a CVV step-up authentication used with a card cryptogram does not require a prior setup or enrollment such as with biometric authentication.

Although embodiments have been described in the context of a card-not-present transaction with an e-commerce merchant, Embodiments can apply in other contexts. For example, Embodiments can be used in person-to-person push payment transactions.

Any of the software components or functions described in this application, may be implemented as software code to be executed by a processor using any suitable computer language such as, for example, Java, C++, or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the embodiments may become apparent to those skilled in the art upon review of the disclosure. The scope of the invention can, therefore, be determined not with reference to the above description, but instead can be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

1. A method comprising:
receiving, by a communication device from a resource provider computer operating a resource provider site, transaction data associated with a transaction conducted at the resource provider site by a user;
providing, by the communication device to a portable transaction device operated by the user, the transaction data via short range wireless communication, wherein the portable transaction device generates a cryptogram based at least on the transaction data and a credential associated with an account;
receiving, by the communication device from the portable transaction device, a payload including at least the cryptogram via the short range wireless communication;
transmitting, by the communication device to a token service computer, a token provisioning request message comprising at least the cryptogram;
receiving, by the communication device from the token service computer, a token provisioning response message comprising a one-time use token associated with the credential upon validation of the cryptogram by a validation server; and
transmitting, by the communication device, the one-time use token to the resource provider computer to finalize the transaction on the resource provider site, wherein the resource provider computer generates and transmits an authorization request message comprising the one-time use token to an authorizing entity computer for authorization.

2. The method of claim 1, wherein the token provisioning response message further comprises a token cryptogram, wherein the communication device transmits the token cryptogram along with the one-time use token to the resource provider computer, wherein the authorization request message includes the token cryptogram along with the one-time use token.

3. The method of claim 1, wherein the authorization request message is routed to the authorizing entity computer through a transaction processing network, and wherein the token service computer and the transaction processing network are managed by separate entities.

4. The method of claim 1, wherein the authorization request message is routed to the authorizing entity computer through a transaction processing network, and wherein the token service computer and the transaction processing network are managed by a same entity, and wherein the authorizing entity computer authorizes the transaction at least based on receiving an indication of the validation of the cryptogram provided by the transaction processing network.

5. The method of claim 1, wherein the communication device receives the credential from the portable transaction device via Near Field Communication (NFC) capability of the communication device and the portable transaction device.

6. The method of claim 5, further comprising:
receiving, by the communication device from the resource provider computer, a prompt to retrieve the credential associated with the account from the portable transaction device, wherein the resource provider computer detects an NFC capability of the communication device prior to transmitting the prompt.

7. The method of claim 1, wherein the payload further includes the credential associated with the account, and wherein the token provisioning request message further comprises the credential associated with the account.

8. The method of claim 1, wherein the one-time use token can only be de-tokenized by the token service computer.

9. A communication device comprising:
a processor; and
a non-transitory computer readable medium, comprising code, executable by the processor to implement steps comprising:
receiving, from a resource provider computer operating a resource provider site, transaction data associated with a transaction conducted at the resource provider site by a user;
providing, to a portable transaction device operated by the user, the transaction data via short range wireless communication, wherein the portable transaction device generates a cryptogram based at least on the transaction data and a credential associated with an account;
receiving, from the portable transaction device, a payload including at least the cryptogram via the short range wireless communication;
transmitting, to a token service computer, a token provisioning request message comprising at least the cryptogram;
receiving, from the token service computer, a token provisioning response message comprising a one-time use token associated with the credential upon validation of the cryptogram by a validation server; and
transmitting the one-time use token to the resource provider computer to finalize the transaction on the resource provider site, wherein the resource provider computer generates and transmits an authorization request message comprising the one-time use token to an authorizing entity computer for authorization.

10. The communication device of claim 9, wherein the steps further comprise:
receiving a token cryptogram in the token provisioning response message; and
transmitting the token cryptogram along with the one-time use token to the resource provider computer, wherein the authorization request message includes the token cryptogram along with the one-time use token.

11. The communication device of claim 9, further comprising:
a Near Field Communication (NFC) antenna configured to communicate with the portable transaction device to receive the credential from the portable transaction device.

12. The communication device of claim 11, wherein the steps further comprise:
receiving an interrogation signal from the resource provider site with respect to an NFC capability of the communication device; and
receiving, from the resource provider computer, a prompt to retrieve the credential associated with the account from the portable transaction device via NFC.

13. The communication device of claim 9, wherein the steps further comprise:
receiving the credential associated with the account as part of the payload; and
incorporating the credential associated with the account in the token provisioning request message.

14. The communication device of claim 9, wherein the one-time use token can only be de-tokenized by the token service computer.

15. The communication device of claim 9, wherein the authorization request message is routed to the authorizing entity computer through a transaction processing network, and wherein the token service computer and the transaction processing network are managed by separate entities.

16. A method comprising:
receiving, by a token service computer from a communication device, a token provisioning request message comprising a credential associated with an account and a cryptogram generated based at least on transaction data associated with a transaction and the credential associated with the account;
generating, by the token service computer, a one-time use token associated with the account upon validating the cryptogram with a validation computer;
transmitting, by the token service computer, the one-time use token to the communication device;
receiving, by the token service computer from a transaction processing network, a detokenization request message including the one-time use token;
retrieving, by the token service computer, the credential associated with the one-time use token upon validating the one-time use token; and
transmitting, by the token service computer to the transaction processing network, the credential associated with the one-time use token, wherein the transaction is processed using the credential.

17. The method of claim 16, further comprising:
transmitting, by the token service computer, the credential and the cryptogram to the validation computer; and
receiving, by the token service computer, a validation response message from the validation computer, wherein the validation response message validates the cryptogram confirming that the credential is associated with the account.

18. The method of claim 16, further comprising:
generating, by the token service computer, a token cryptogram along with the one-time use token, and
transmitting, by the token service computer, the token cryptogram along with the one-time use token to the communication device, wherein the communication device transmits the token cryptogram along with the one-time use token to a resource provider computer to finalize the transaction.

19. The method of claim 16, wherein the token service computer and the transaction processing network are managed by separate entities.

20. The method of claim 16, wherein the token service computer and the transaction processing network are managed by a same entity, and wherein the transaction is authorized at least based on an indication of validation of the cryptogram.
